(19) United States
(12) Patent Application Publication
(10) Pub. No.: US 2026/0259888 A1
(43) Pub. Date: Sep. 3, 2026

(54) A METHOD AND SYSTEM FOR HANDLING DATA ASSETS

(71) Applicant: Aspect Systems Sweden AB, Västerås (SE)

(72) Inventors: Mikael RUDIN, Västerås (SE); Johan ANDERSSON, Västerås (SE)

(21) Appl. No.: 19/165,173

(22) PCT Filed: Mar. 15, 2024
(86) PCT No.: PCT/SE2024/050238

§ 371 Date: Sep. 15, 2025

(30) Foreign Application Priority Data
Mar. 15, 2023 (SE) 2350286-7

(51) Int. Cl. G06F 16/2458; G06F 16/25; G06F 16/28

(52) U.S. Cl. CPC G06F 16/2471; G06F 16/256; G06F 16/285

(57) ABSTRACT

A computer-implemented method for handling data assets of different data providers, wherein the method comprises providing an intermediate system having a client accessible interface, the intermediate system having a plurality of asset interfaces providing access to a plurality of data assets stored at different devices being hosted by different data providers. Receiving select queries from a client, by said client accessible interface, for providing access to specific data assets. Further the method comprises clustering, based on said query, at least a part of said plurality of data asset interfaces into different objects and providing, by one of said objects, data asset access to said client in accordance with said select query, wherein at least some of the provided data assets are hosted by different data providers and stored at different devices.

### TECHNICAL FIELD

The present disclosure relates to a computer-implemented method for handling data assets of different data providers. The disclosure further relates to a computer-readable storage medium for performing the method herein and a system for handling data assets.

### BACKGROUND

Intermediate systems could be described as software intermediaries that allows for e.g. two applications to communicate with each other. For example, a client application can communicate with the intermediate system, by for example, querying the intermediate system. The intermediate system may then communicate with a server device to retrieve information/data assets and then present information/data assets to the client device in accordance with the query. This information/data asset may have been provided to the server device by a client of another application and the information has been shared by use of the intermediate system.

A drawback with such intermediate systems that are in the present art is that to be able to provide data, the data is duplicated into a common data storage and/or common data model in control by or owned by the intermediate system. Thus, the data provider loses ownership of their data. Accordingly, solutions of the present art require data ownership to be given up (as the data is moved to a central intermediate repository) and/or the client application code needs to be aware of the location of the data. Moreover, the way to organize data requires an agreement between the data providers of a common data model, without this current art does not support multiple providers that jointly provide view of data assets to a client application.

Accordingly, there is a need for a solution that is able for data providers to retain ownership of their data assets and/or allowing an intermediate system to, in an efficient manner, handle queries by client applications in client devices, without requiring the data providers to harmonize data models or use a common data storage.

Based on the above there is room for improvements in order to provide a method for handling data assets in a more efficient and secure manner. Specifically, there is a need for a method for handling assets, so that the asset provider do not lose ownership of their assets and/or handling of the assets, where assets can be provided based on a query from a client application to an intermediate system resulting in access to data assets of different data providers.

### SUMMARY

It is therefore an object of the present disclosure to provide a method for handling data assets to mitigate, alleviate or eliminate one or more of the above-identified deficiencies and disadvantages.

This object is achieved by means of a method and system as defined in the appended claims. The present disclosure is at least partly based on the insight that by providing a method and system for handling assets as defined in the appended claims, queries of client applications/devices seeking access to data assets of data providers will be handled more efficiently. Moreover, the present disclosure may also prevent data providers from being exposed to the client and intermediate system and giving up control of said data asset.

The present disclosure provides a computer-implemented method for handling (and/or) providing access to) data assets of different data providers, the method comprising the steps of providing an intermediate system having a client accessible interface, the intermediate system having a plurality of asset interfaces providing/being configured for providing access to a plurality of data assets stored at different devices being hosted by different data providers. Moreover, the method comprises the step of receiving select queries from a client, by said client accessible interface, the select queries being utilized by said client for gaining access to (specific) data assets. Moreover, the method comprises the step of clustering, based on said query, at least a part of said plurality of asset interfaces into one or more objects. Moreover, the method comprises providing, by one of said objects, data asset access to said client in accordance with said select query, wherein at least some of the provided data assets are hosted by different data providers and stored at different devices.

An advantage of the method is that it allows a client device/application to gain access to data assets that are stored and hosted by different data provides. Thereby, the data providers will not lose ownership of data thereof.

The method herein may be performed by a system for handling data assets, such a system may comprise a client accessible interface. Further, the system may have access to a plurality of asset interfaces stored at different devices and hosted by different data providers.

Moreover, the step of providing data asset access is performed by utilizing combined asset interfaces clustered into one or more objects.

An advantage of this is that asset interfaces may be combined to allow access to data assets provided by different data providers. Thus, the data assets as such may also be provided in a more complete manner.

Further, the method may comprise the step of masking the data provider of each of said plurality of data assets from the client and the intermediate system.

Accordingly, the data providers identity may be hidden from the client device/application and intermediate system/device.

Further, the step of providing data asset access may comprise determining at least one object having asset interfaces and asset interface implementations matching the query and providing, by said at least one object, access of data assets to said client or access to data assets of said client by means of said asset interface

Each object may comprise a plurality of asset interfaces being receptive to requests from said client. Thus, the client device/application may further query the object using asset interfaces thereof directly for additional data or other data.

Moreover, prior to clustering, the method may comprise requesting, by said intermediate system, from at least two of said data providers, information indicative of asset interfaces associated to said query for clustering said asset interfaces into at least one object based on said information.

An advantage of this is that the system may, in real-time, form objects according to the query of the client.

The step of providing data asset access may be performed by at least one asset interface implementation realized by an asset objects, wherein the asset object is implemented by one of said data providers. However, the data is stored in the database of the data provider and accessed through a data model of the data provider. Thereby, the asset object may function as an intermediate point for enabling access to the data seeked by the client application. An advantage of this is that there is no need for an additional database that gathers data from each provider. Further, the objects may cluster relevant asset interfaces and asset interface implementations in one object, thereby allowing for several asset objects of different providers to jointly provide the data queried by the client.

The method according to any one of the preceding claims, wherein the different data providers is a set of data providers, wherein the set of data providers is dynamic. Accordingly, the data providers may be added or remove themselves and/or their data.

Further, prior to clustering, the method may comprise the step of prior to clustering: selecting asset interfaces, each selected asset interface being associated to said select query. Further, determining asset objects of each provider implementing said asset interface for forming/executing asset interface implementations. Further, the method may comprise clustering asset interface implementations into at least one object. and/or into several objects of different categories. The type of data asset may be property of data assets of the provider, type of database of the provider, type of data model of the provider. The objects may be formed prior to or after the selecting. A single asset interface may be used in several objects.

Thus, the method may identify/search for implementations of specific asset interfaces that are associated to said query by querying the data provider for said implementation. When identifying an implementation, an asset interface implementation is formed, which in turn can give a client access to the seeked data.

The step providing data asset access may comprise providing access to implemented asset interfaces implemented by asset objects (by said objects), thereby getting access to data without any information of the identity of the provider as only the asset interfaces implemented by the provider are “visible” for the client. Moreover, the access may be provided in real-time. An advantage of this is that access to the data is controlled by the data provider, thereby can data be provided without intermediate storage in the provider.

### BRIEF DESCRIPTION OF THE DRAWINGS

FIG. 1 illustrates a system 1 in accordance with some aspects of the disclosure herein;

FIG. 2 illustrates a method 100 in the form of a flowchart in accordance with some aspects of the disclosure herein;

FIG. 3 illustrates a method 100 in the form of a flowchart in accordance with some aspects of the disclosure herein;

### DETAILED DESCRIPTION

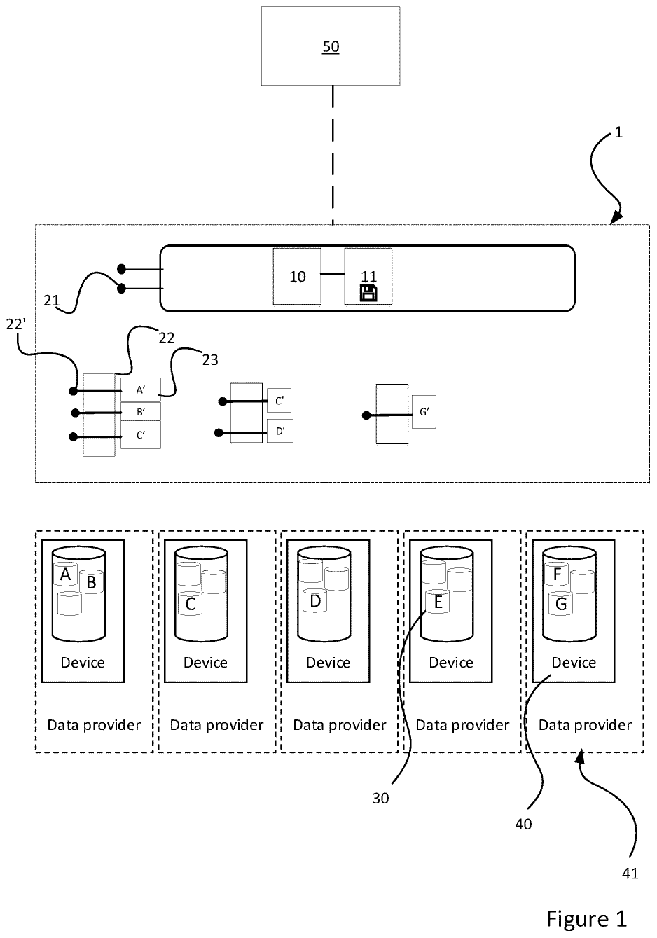

FIG. 1 illustrates a system 1 (which may be referred to as an intermediate system) for handling data assets 30 of different data providers, having a client accessible interface 21, the system 1 having asset interfaces 22′, each asset interface being configured for providing access to a plurality of data assets 30 stored at different devices 40 being hosted by different data providers 41, the system 1 being configured to receive select queries from a client 50, by said client accessible interface 21, for providing access to specific data assets 30. Further, the system 1 may be configured to cluster, based on said query, asset interfaces 22′ giving access to said plurality of data assets 30 into different objects 22.

Further, the system 1 is configured to provide, by one of said objects 22, data asset access to said client (by at least one of said interfaces 22′) in accordance with said select query, wherein at least some of the provided data assets are hosted by different data providers and stored at different devices.

FIG. 1 illustrates that devices 40 comprises different data assets 30. Further, FIG. 1 illustrates that one of the objects 22, comprises/collects asset interfaces 22′ which are implemented by data providers by asset objects 23, denoted A′, B′, E′ which are collected from two different devices hosted/owned by/stored by two different data providers 41. The data objects A′, B′, E′ may be interlinked/associated with the data assets A, B, E. Thus, the interfaces 22′ and the asset objects 23 implementing said interfaces may form an asset interface implementation for providing access to said data A, B, E respectively. It should be noted that several data providers 41 may implement an asset interface 22′. Thus, each data provider 41 may store/create asset objects 23 which implement specific interfaces.

Accordingly, for example in FIG. 1, a client 50 may seek access to a data asset 30 denoted A. Thus, the system 1 may identify/determine a specific asset interface 22′ associated to said data asset A.

Further, the system 1 may query each data provider 41 for asset objects 23 that implement the specific asset interface 22′ that can execute/solve the query of the client 50. For each identified object that implement said specific asset interface 22′, an asset interface implementation (asset object) may be determined and executed as one or several asset objects 23.

The expression “client accessible interface” may refer to a boundary across which a client and the system exchange information. Also, it may refer to a software layer made available by the system allowing a query to access data assets. The system may have a plurality of client accessible interfaces. A client accessible interface may be created in real-time based on a query of a client to the system to a general interface thereof.

The expression “object” may refer to a data type that comprises properties and methods. Property may be in the form of fields/variables and methods may be functions and/or events. Thus, the system herein may cluster asset interfaces and asset objects implementing various interfaces (or variables/functions thereof) into objects.

The expression “data asset” may refer to any kind of information/data stored at the devices of the different data providers.

The expression “asset object” may refer to an asset interface implemented by a data provider, the asset object giving access to at least some of the data of the provider. The asset object may comprise instructions/descriptions/location data of a data asset at the devices of the data provider. Upon matching an asset interface with a corresponding asset object implementing said asset interface, an asset interface implementation (see 22′ linked to A′ in FIG. 1 for such) is formed. Such an implementation allowing for access to data accessible by the asset object via the asset interface 22′.

The expression “data asset access” may refer to the enablement of access to specific data assets, by means of an asset interface.

The expression “asset interface” may refer to a description of properties and methods that may be implemented by an asset object.

As illustrated in FIG. 1, each object 22 may comprise asset interfaces 22′ also, allowing the client to communicate and query the objects 22 after being enabled access to a specific object by the system 1. The object 22 may create specific asset interfaces 22′, in real-time, based on client queries.

The system 1 may comprise control circuitry 10 and at least one memory device 11. The objects 22, and client interfaces 21, 22′ may be created/modified by the control circuitry 10.

The at least one memory device 11 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used.

The control circuitry 10 may be arranged to run instruction sets in the memory device 11 for operating a method (such as the method described herein) as such or for forming objects, clustering asset interfaces, enable access etc. The control circuitry 10 may be any suitable type such as a microprocessor, digital signal processor (DSP), ASIC (Application Specific Integrated Circuit), FPGA (Field Programmable Gate Array), or a combination of these, or other similar processing means arranged to run instruction sets. The computer readable storage medium may be of non-volatile and/or volatile type and transitory or non-transitory type; for instance RAM, EEPROM, flash disk and so on. It should be noted that the memory device 11 may be integrated with the control circuitry 10.

Memory device 11 may be used to store any calculations made by control circuitry 10 and/or any data received via output and input interfaces. In some aspects, each control circuitry 10 and each memory device 11 may be considered to be integrated. In some embodiments, the memory device 11 and related data are stored in a cloud server accessible by the system 1.

There is also provided a computer-readable storage medium storing one or more programs configured to be executed by one or more control circuitry 10 of the system 1, the one or more programs including instructions for performing the method according to any aspect herein.

FIG. 1 further illustrates that one object 22 may cluster/combining asset interfaces 22′ of different providers into said object 22. Combining may refer to merging asset interfaces or collecting asset interfaces.

FIG. 1 further illustrates that each object may comprise or provide in real-time, access to a plurality of data access interfaces 22′ being receptive to requests from said client. The requests may be specific requests for additional queries based on said specific object the client 50 has access to. Further, even though FIG. 1 illustrates a plurality of data providers 41, the, different data providers may be dynamic i.e. may be changed in real-time based on whether an additional data provider 41 grants access to their data assets 30 by means of asset objects 23, or whether data providers 41 continuous grant access, or whether data providers 41 disables access to their data assets 30. Thus, the number of data providers 41 is dynamic.

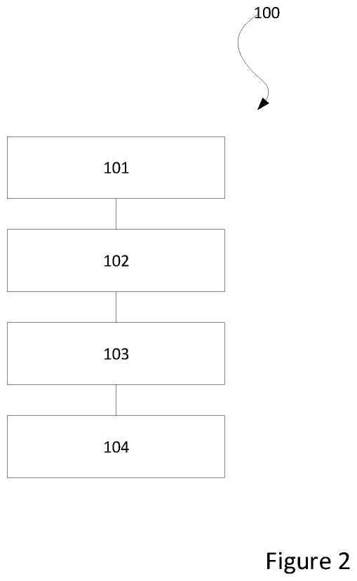

FIG. 2 schematically in the form of a flowchart illustrates a method 100, the method comprising the steps of providing 101 an intermediate system having a client accessible interface, the intermediate system having access to a plurality of data assets stored at different devices being hosted by different data providers. The method 100 further comprises receiving 102 select queries from a client, by said client accessible interface, for providing access to specific data assets (by using objects 22 as an underlying layer). Further, the method comprises clustering 103, based on said query, at least a part of said plurality of data asset interfaces into different objects. The clustering may be performed in real-time after a select query of a client. Further, the method 100 comprises the step of providing 104, by one of said objects, data asset access to said client in accordance with said select query, wherein at least some of the provided data assets are hosted by different data providers and stored at different devices.

The step of providing data asset access may be performed by at least one asset interface implementation realized by an asset object, wherein the asset object is implemented by one of said data providers Further, the step of providing data asset access may comprise providing access to assets directly from databases and/or data models of each data provider. In some aspects, it comprises providing real-time access to data asset directly from databases and/or data models of each data provider. Thus, the system 1 herein as disclosed in FIG. 1 may provide data access through said asset objects 23 forming interface implementations with said interfaces 22′ without any data assets stored in the system. Thus, each interface 22′ may connect/communicate to a corresponding implementation thereof, realized by said asset objects 23. Accordingly, the client can gain access to data through said asset object 23 and said interface 22′ being receptive to the query.

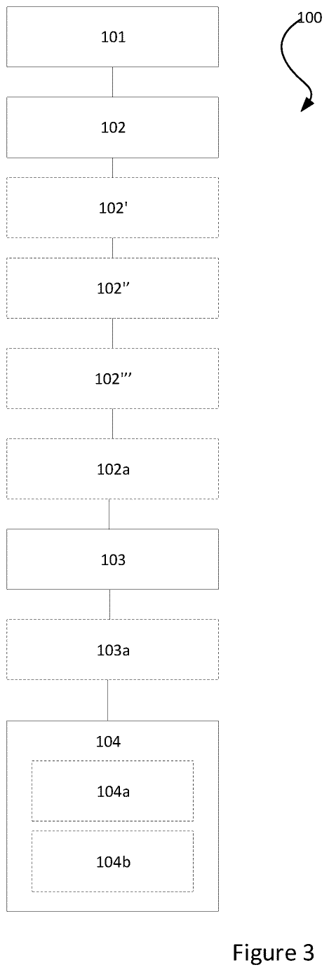

FIG. 3 illustrates the method 100 in accordance with some aspects herein showing additional steps of the method 100, note that all steps are not necessarily performed and the order of the steps may be interchanged.

The method 100 may further comprise the step of masking 103a the data provider of each of said plurality of data assets from the client, masking 103 may comprise, disabling the client and/or the system as such from identifying the data provider. Thus, the system and/or the client will not be able to see any indication of data provider identity.

As further illustrated in FIG. 3. The step of providing data asset access may comprise determining 104a at least one object having access to asset interfaces matching the query or being associated to the query and providing 104b, by said at least one object, access of data assets to said client.

The determining 104a may be performed checking for each data provider 41 whether said providers 41 have any data asset associated to the query of the client. E.g. the query from the client may be “Identify the presence of rain in cities having water reservoirs?”, each data provider may then receive queries from the intermediate system based on the query of the client, the query may be the explicit query of the client or fractions of the query of the client such as “Cities with reservoirs” or “Cities with the presence of rain”. Then, the asset interfaces 22′ may query each data provider 41 for implementations of corresponding asset interfaces 22′ (in the form of asset objects 23). Upon identifying asset objects 23 implementing corresponding asset interfaces 22′, an asset interface implementation may be formed enabling access to e.g. two different asset interface implementations, one having access to data of “rain in cities” and the other one having access to data of “specific cities having water reservoirs”. An asset interface implementation may be the connection of the asset interface 22′ with an asset object 23. In that case, the asset object 23 has implemented a specific asset interface 22′ (in this case the implementation allows for getting access to data with information regarding presence of rain in cities having water reservoirs). Further, the object may group these interfaces. The grouping may be performed prior and/or after querying the data providers.

Thus, the method 100 may request 102a, by said intermediate system, from at least two of said data providers, information indicative of data assets associated to the query of the client for clustering said data assets into at least one object based on said information.

As further disclosed in FIG. 3, In some aspects herein, the method 100 may comprise the step of, prior to clustering creating 102′, based on said select query from the client, queries for each data provider, each query being associated to said select query, wherein each query for each data provider comprises a clause adapting the query to a type of asset interfaces provided by said device of said data provider. Further, the method 100 may comprise determining 102″ data assets of each provider matching the query for clustering said data assets into an object.

The type of asset objects provided by the data provider may be retrieved from the data provider based on information provided by the data provider when connecting to the system or retrieved by the system when querying the data provider. Type of asset object may refer to properties of the data asset, properties of the database/server device storing the data asset or data models of the data provider storing the data asset or any combination thereof.

1. A computer-implemented method for handling data assets of different data providers, the method comprising:
providing an intermediate system having a client accessible interface, the intermediate system having a plurality of asset interfaces providing access to a plurality of data assets stored at different devices being hosted by different data providers;
receiving select queries from a client, by said client accessible interface, for providing access to data assets;
clustering, based on said query, at least a part of said plurality of asset interfaces into different objects;
providing, by one of said objects, data asset access to said client in accordance with said select query, wherein at least some of the provided data assets are hosted by different data providers and stored at different devices.

2. The method according to claim 1, wherein the step of providing data asset is performed by utilizing combined asset interfaces clustered into one object.

3. The method according to claim 1, wherein the method further comprises the step of:
masking the data provider of each of said plurality of data assets from the client.

4. The method according to claim 1, wherein the step of providing data asset access comprises:
determining at least one object having access to asset interfaces matching the query;
providing, by said at least one object, access of data assets to said client.

5. The method according to claim 1, wherein, each object comprises a plurality of data asset interfaces being receptive to requests from said client.

6. The method according to claim 1, wherein prior to clustering, the method comprises:
requesting, by said intermediate system, from at least one of said asset interfaces, information indicative of data assets associated to said query for clustering said data asset interfaces into at least one object based on said information.

7. The method according to claim 1, wherein the step of providing data asset access is performed by at least one asset interface implementation realized by an asset object, wherein the asset object is implemented by one of said data providers.

8. The method according to claim 1, wherein the different data providers is a set of data providers, wherein the set of data providers is dynamic.

9. The method according to claim 1, wherein the method comprises, prior to clustering:
selecting asset interfaces each selected asset interface being associated to said select query;
determining asset objects of each provider implementing said asset interface for forming asset interface implementations; and
clustering asset interface implementations or asset interfaces into at least one object.

10. The method according to claim 1, wherein the step providing data asset access comprises providing access to data assets directly from databases and/or data models of each data provider.

11. A computer-readable storage medium storing one or more programs configured to be executed by one or more control circuitry of a system, the one or more programs including instructions for performing the method of claim 1.

12. A system for handling data assets of different data providers, the system having a client accessible interface the system having access to a plurality of asset interfaces providing access to a plurality of data assets stored at different devices being hosted by different data providers the system being configured to:
receive select queries from a client, by said client accessible interface for providing access to data assets;
cluster, based on said query, at least a part of said plurality of asset interfaces into different objects;
providing, by one of said objects data asset access to said client in accordance with said select query, wherein at least some of the provided data assets are hosted by different data providers and stored at different devices.
